(19) United States
(12) Patent Application Publication
(10) Pub. No.: US 2025/0103257 A1
(43) Pub. Date: Mar. 27, 2025

(54) PRINTING SYSTEM AND METHOD FOR CONTROLLING PRINTING SYSTEM

(71) Applicant: CANON KABUSHIKI KAISHA, Tokyo (JP)

(72) Inventor: FUMIAKI HIROSE, Meerbusch (DE)

(21) Appl. No.: 18/887,668

(22) Filed: Sep. 17, 2024

(30) Foreign Application Priority Data
Sep. 21, 2023 (JP) 2023-155626

(51) Int. Cl. G06F 3/12

(52) U.S. Cl. CPC G06F 3/1257; G06F 3/1205

(57) ABSTRACT

Disclosed is a printing apparatus for requesting generation of image data, i.e. bitmap data, by an information processing apparatus when a sheet type of a color profile designated in a print job does not match a sheet type detected by the printing apparatus.

### BACKGROUND

### Field

The present disclosure relates to a printing system and a method for controlling a printing system.

### Description of the Related Art

A technique for automatic detection of sheet type setting has been used in printing apparatuses to save users' time and trouble. Japanese Patent Application Laid-Open No. 2019-184812 discusses a technique in which a printing apparatus detects a sheet type of a currently conveyed sheet and, based on the detected sheet type, automatically changes processing to produce an output according to an output setting registered in advance.

However, in the technique discussed in Japanese Patent Application Laid-Open No. 2019-184812, in a case where processing performed on bitmap data transmitted from a printing control apparatus is inappropriate for the sheet type detected by the printing apparatus, an image is generated based on the bitmap data, which may lead to degradation in the quality of a printed product.

### SUMMARY

The present disclosure has been made in view of the above-described issue, and is directed to suppressing degradation in the quality of a printed product to be produced in image printing based on bitmap data transmitted from a printing control apparatus.

According to an aspect of the present disclosure, a printing system is provided that include a printing control apparatus and a printing apparatus. The printing control apparatus includes a first receiving unit configured to receive a sheet type setting; a designation unit configured to designate a profile based on the sheet type setting; a generation unit configured to generate bitmap data based on the designated profile; and a first transmission unit configured to transmit, to the printing apparatus, the generated bitmap data and information on the profile including the sheet type setting. The printing apparatus includes a second receiving unit configured to receive the bitmap data and the information on the profile; a detection unit configured to detect a type of sheet being conveyed along a conveyance path; and a second transmission unit configured to transmit to the printing control apparatus, in a case where the type of sheet detected by the detection unit does not match a sheet type corresponding to the information on the profile, a request for generation of bitmap data based on the type of sheet detected by the detection unit. The first transmission unit transmits, to the printing apparatus, the bitmap data that has been generated based on the request. The printing apparatus is configured to print an image on a sheet, based on the bitmap data that has been received by the second receiving unit.

Further features of the present disclosure will become apparent from the following description of exemplary embodiments with reference to the attached drawings.

### BRIEF DESCRIPTION OF THE DRAWINGS

FIG. 1 is a diagram illustrating a configuration of a printing system according to an embodiment.

FIGS. 2A and 2B are diagrams each illustrating a configuration in a printing apparatus according to an embodiment.

FIG. 3A to 3C are diagrams illustrating an example of a setting method for automatically detecting a sheet type according to an embodiment.

FIG. 4 is a diagram illustrating a print job setting screen according to an embodiment.

FIG. 5 is a diagram illustrating a sheet type check screen according to an embodiment.

FIG. 6A is a flowchart illustrating a first embodiment of processing that is performed by an information processing apparatus. FIG. 6B is a flowchart illustrating the first embodiment of processing that is performed by the printing apparatus. FIG. 6C is a flowchart illustrating a second embodiment of processing that is performed by the information processing apparatus. FIG. 6D is a flowchart illustrating the second embodiment of processing that is performed by the printing apparatus.

FIG. 7 is a diagram illustrating another sheet type check screen according to an

embodiment.

FIG. 8 is a diagram illustrating a setting check screen according to an embodiment.

FIG. 9 is a flowchart illustrating an example of processing that is performed by the printing apparatus according to an embodiment.

FIG. 10 is a flowchart illustrating the example of processing that is performed by the information processing apparatus according to an embodiment.

FIG. 11 is a diagram illustrating a check enable/disable setting screen according to an embodiment.

### DESCRIPTION OF THE EMBODIMENTS

Hereinafter, exemplary embodiments of the present disclosure will be described with reference to the drawings.

A first exemplary embodiment will be described.

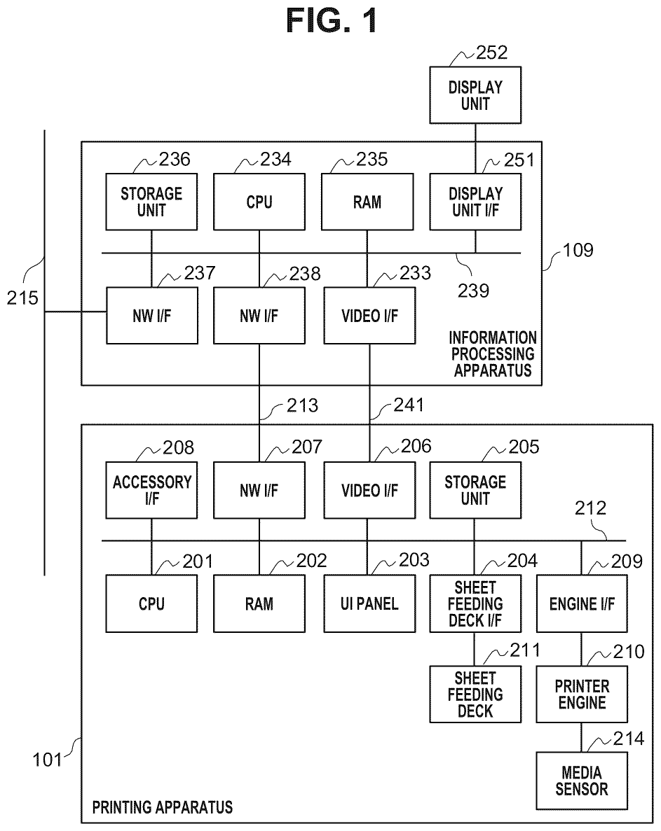

FIG. 1 is a diagram illustrating an example of a configuration of a printing system according to an exemplary embodiment.

In FIG. 1, the printing system includes a printing apparatus 101 and an information processing apparatus 109 which is an example of a printing control apparatus.

An example of the configuration of the printing apparatus 101 is described herein.

A central processing unit (CPU) 201 is configured to control various operational units of the printing apparatus 101. The CPU 201 controls execution of a program stored in a storage unit 205 and loaded into a random access memory (RAM) 202.

The printing apparatus 101 may include one or more pieces of dedicated hardware different from the CPU 201, and the dedicated hardware may execute at least a part of processing that is performed by the CPU 201. Examples of the dedicated hardware include an application specific integrated circuit (ASIC), a field programmable gate array (FPGA), and a digital signal processor (DSP). The printing apparatus 101 may include a hardware processor, for example, a graphics processing unit (GPU), other than a CPU instead of or in addition to the CPU 201.

The RAM 202 is a type of volatile storage device that can be directly accessed by the CPU 201.

The RAM 202 is used as a work area of the CPU 201 or a temporary data storage area. The storage unit 205 functions as a temporary storage area and a work memory during operation of the printing apparatus 101. An engine interface (I/F) 209 controls communication with a printer engine 210 and performs control of the printer engine 210. A media sensor 214 is connected to the printer engine 210. In the present exemplary embodiment, a description will be given of a case where the media sensor 214 is used to detect a sheet type. While a sheet to be printed is a piece of paper, the sheet is not limited to a piece of paper. For example, the sheet may be a paper medium, such as an envelope, other than a piece of paper, a plastic film, such as an overhead projector (OHP) sheet, or a sheet of cloth.

A sheet feeding deck I/F 204 controls communication with a sheet feeding deck 211 and performs control of the sheet feeding deck 211. A user interface (UI) panel 203 serves as an interface via which a user performs general operations of the printing apparatus 101. In the present exemplary embodiment, the UI panel 203 includes a capacitive touch panel. A network I/F (hereinafter, referred to as NW I/F) 207 is connected to a NW I/F 238 of the information processing apparatus 109 via a cable 213. The NW I/F 207 controls communication between the information processing apparatus 109 and the printing apparatus 101. In the present exemplary embodiment, the interfaces connected to system buses 212 and 239, respectively, are directly connected to each other. A connection between the information processing apparatus 109 and the printing apparatus 101 allows the information processing apparatus 109 and the printing apparatus 101 to communicate with each other may be, for example, a connection via a network, and is not particularly limited.

A video I/F 206 is connected to a video I/F 233 via a video cable 241. The video I/F 206 controls communication of image data between the information processing apparatus 109 and the printing apparatus 101. The connection interface to the printing apparatus 101 in the information processing apparatus 109 may be in a form into which the function of the NW I/F 238 and the function of the video I/F 233 are integrated. The connection interface to the information processing apparatus 109 in the printing apparatus 101 may be in a form into which the function of the NW I/F 207 and the function of the video I/F 206 are integrated. The printing apparatus 101 is connected to an accessory via an accessory I/F 208 and communicates with the accessory.

An example of a configuration of the information processing apparatus 109 will be described.

A CPU 234 is configured to control various operational units in the information processing apparatus 109. The CPU 234 controls execution of a program stored in a storage unit 236 and loaded into a RAM 235. The information processing apparatus 109 may include one or more pieces of dedicated hardware different from the CPU 234. The information processing apparatus 109 may include a hardware processor other than a CPU. These examples are similar to the examples in the above description of the printing apparatus 101, and the detailed redundant description is not repeated here, for conciseness.

The RAM 235 is a type of volatile storage that can be accessed directly by the CPU 234. The RAM 235 is used as a work area of the CPU 234 or a temporary data storage area. The storage unit 236 functions as a temporary storage area and a work memory during operation of the information processing apparatus 109. A NW I/F 237 is connected to a cable 215 and is connected to an external network via the cable 215. A display unit I/F 251 is connected to a display unit 252. The display unit I/F 251 controls exchanging of information to receive an input for control of the information processing apparatus 109, and the display unit 252 displays a screen or the like including the information. Each screen which is to be described below in the exemplary embodiments has a function serving as a graphical user interface (GUI).

Some printing systems include a digital front end (DFE) unit. In such a printing system, an image processed by the DFE unit is input to the printing apparatus as an input image. The processing performed by the DFE unit includes processing based on a sheet type. Consequently, there can be a case where a sheet type that has been intended in the processing may be different from a sheet type actually detected by the printing apparatus. A description is provided herein of a case where the printing system is such a printing system, and the information processing apparatus 109 serves as the DFE unit.

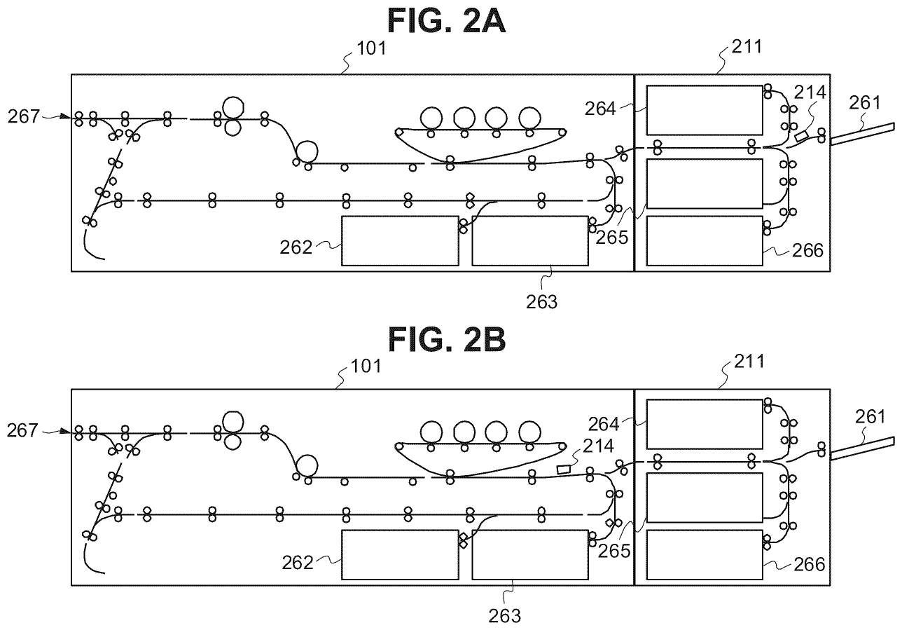

FIGS. 2A and 2B are schematic diagrams each illustrating an example of a path (conveyance path) along which a sheet is conveyed in the printing apparatus 101 and an example of main components on the path according to an embodiment.

The example illustrated in FIG. 2B differs from the example illustrated in FIG. 2A in the location of the media sensor 214. Sheet feeding trays 262 to 266 are trays that store sheets therein in the printing apparatus 101 and the sheet feeding deck 211. A manual feeding tray 261 is a tray on which a sheet is placed by the user when a sheet different from the sheets stored in the sheet feeding trays 262 to 266 is printed. A sheet of the same type as any of the sheets stored in the sheet feeding trays 262 to 266 may also be set in the manual feeding tray 261.

A sheet fed from any one of the manual feeding tray 261 and the sheet feeding trays 262 to 266 is conveyed through a path indicated by a solid line passing between rollers, as illustrated in FIGS. 2A and 2B, and is discharged from the printing apparatus 101 through a sheet discharge port 267. Various accessories, such as a finisher, may be connected as a subsequent stage of the printing apparatus 101. The media sensor 214 is a sensor for automatically detecting a type of a sheet being conveyed through the conveyance path. In the example illustrated in FIG. 2A, the media sensor 214 automatically detects a type of a sheet conveyed from the manual feeding tray 261. In the example illustrated in FIG. 2B, the media sensor 214 automatically detects a type of a sheet conveyed from any one of the sheet feeding trays 262 to 266. The media sensor 214 measures a feature amount (e.g., surface property, grammage, and the like) of the sheet. The printing apparatus 101 stores therein information that is used to identify a feature amount of a sheet and a type of the sheet corresponding to the feature amount, for example. In this case, based on the information, the printing apparatus 101 identifies a type of the sheet corresponding to the feature amount of the sheet measured by the media sensor 214, whereby the type of the sheet is detected. The technique of detecting a type of a sheet by the media sensor 214 is a known technique, and the detailed description will be omitted. In the following description, when the manual feeding tray 261 and the sheet feeding trays 262 to 266 are not distinguished from each other, they may collectively be referred to as sheet feeding trays. In the following description, a type of a sheet may be referred to as a sheet type.

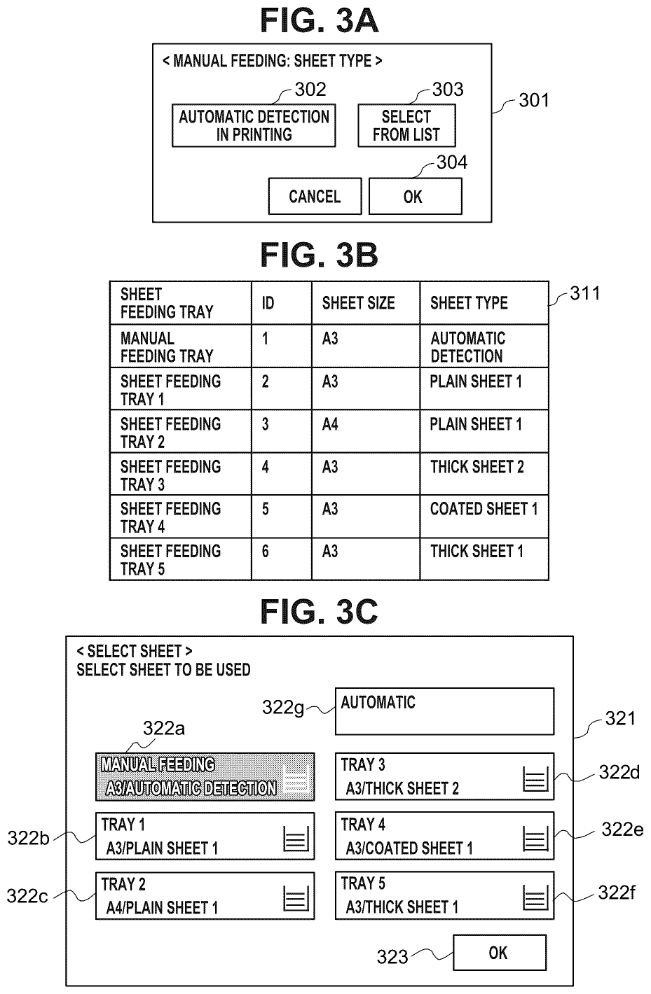

FIGS. 3A to 3C are diagrams illustrating an example of a setting method for automatically detecting a type of a sheet.

FIG. 3A is a diagram illustrating an example of a setting screen 301 on which a sheet type is set. A setting screen 301 is a screen displayed on the UI panel 203 by the CPU 201. The setting screen 301 is displayed in response to a sheet being placed on the manual feeding tray 261. Determination of whether a sheet has been placed on the manual feeding tray 261 is performed by a sensor, for example.

The user selects either an automatic detection button 302 or a select-from-list button 303, and then selects an OK button 304. In response to the selection of the OK button 304, the sheet type setting is determined, and information about the sheet type setting is stored in the storage unit 205 or the like (as described below). In a case where the automatic detection button 302 is selected, the printing apparatus 101 detects a sheet type of a sheet conveyed first in a print sequence by using the media sensor 214. In a case where the select-from-list button 303 is selected, the user selects an appropriate sheet type from a list of sheet types. This selection method has been widely employed and is known, and therefore, the detailed description will be omitted.

FIG. 3B is a diagram schematically illustrating an example of sheet type setting information 311 which is setting information about sheet types. The sheet type setting information 311 is stored in, for example, the storage unit 205. The sheet type setting information 311 is information including entries with respect to IDs each associated with a different one of the sheet feeding trays. Each entry includes at least information on a sheet size and information on a sheet type. As the information on a sheet type, the information set in the setting screen 301 is stored. For example, in the entry of the manual feeding tray having 1 as its ID, information determined by selecting the automatic detection button 302 and then selecting the OK button 304 in the setting screen 301 is stored. The printing apparatus 101 retrieves the sheet type setting information 311 from the storage unit 205 in execution of a print job and performs print processing based on information on a sheet feeding tray set by the print job. The sheet type setting information 311 is also transmitted to the information processing apparatus 109 via the NW I/F 207 and the NW I/F 238 and is also stored in the storage unit 236.

FIG. 3C is a diagram illustrating an example of a sheet selection screen 321. A sheet selection screen 321 is a screen on which a sheet is selected. The sheet selection screen 321 displays information indicating a size and a type (sheet size and sheet type) of a sheet placed on each sheet feeding tray. The CPU 201 generates the sheet selection screen 321 based on the sheet type setting information 311 retrieved from the storage unit 205 and displays the sheet selection screen 321 on the UI panel 203. The user selects one of sheet feeding selection buttons 322a to 322g displayed on the sheet selection screen 321 and then selects an OK button 323. The CPU 201 sets a sheet (sheet feeding tray) corresponding to the sheet feeding selection button selected by the user as a sheet (sheet feeding tray) to be used in printing. The sheet feeding selection button 322g is selected in a case where a specific sheet feeding tray is not selected. In a case where the sheet feeding selection button 322g is selected, the printing apparatus 101 automatically determines a sheet (sheet feeding tray) to be used for printing. In the sheet selection screen 321 illustrated in FIG. 3C, the manual feeding tray 261 has been selected. In the sheet type setting information 311 illustrated in FIG. 3B, with respect to the manual feeding tray having 1 as its ID, the sheet size is set to A3 and the sheet type is set to automatic detection. Thus, in the sheet selection screen 321 illustrated in FIG. 3C, information indicating “A3” as the sheet size and “automatic detection” as the sheet type is displayed on the sheet feeding selection button 322a.

Here, the term “automatic detection” refers to detection of a sheet type by using the media sensor 214.

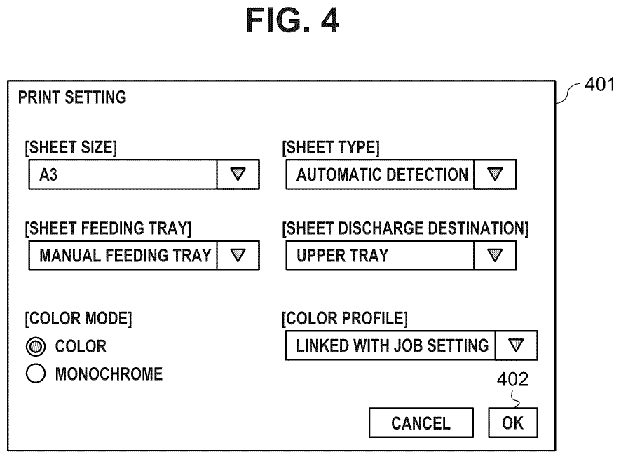

FIG. 4 is a diagram illustrating an example of a print job setting screen 401. A print job setting screen 401 is a screen that is displayed on the display unit 252 by the CPU 234 when a print job is input from the information processing apparatus 109 to the printing apparatus 101. Based on information input to the print job setting screen 401 displayed on the display unit 252, the information processing apparatus 109 generates a print job and instructs the printing apparatus 101 to perform printing. FIG. 4 illustrates a case in which settings of a sheet size, a sheet type, a sheet feeding tray, a sheet discharge destination, a color mode, and a color profile are received via the print job setting screen 401.

In the print job setting screen 401 illustrated in FIG. 4, automatic detection is designated as the sheet type and the manual feeding tray is designated as the sheet feeding tray. That is, the print job setting screen 401 illustrated in FIG. 4 exemplifies a case where, after the start of a print job, a sheet placed on the manual feeding tray 261 is conveyed, i.e., a sheet is fed from the manual feeding tray 261, and a sheet type of the sheet is detected using the media sensor 214.

As options of the color profile, a color profile linked with a sheet type setting designated by the print job is included in addition to a color profile associated with a specific sheet type. In a case where there is no corresponding color profile as a color profile linked with the sheet type setting that is designated by a print job, an initial value is applied. In the present exemplary embodiment, a color profile for plain sheets is applied as an initial value.

In the present exemplary embodiment, information, such as a sheet size, a sheet type, a sheet feeding tray, a sheet discharge destination, color mode, and a color profile, selected in the print job setting screen 401 at the timing when an OK button 402 is selected is set in the print job.

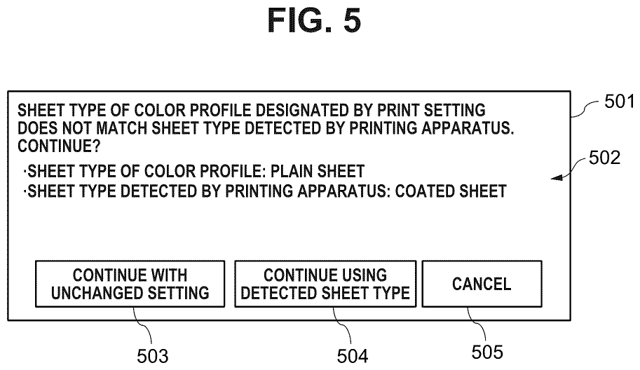

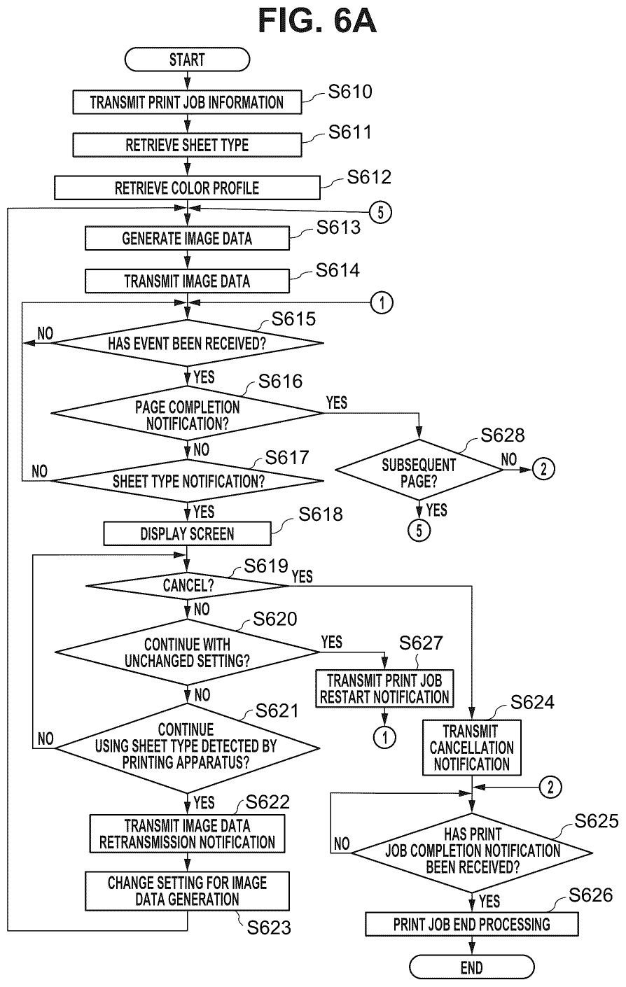

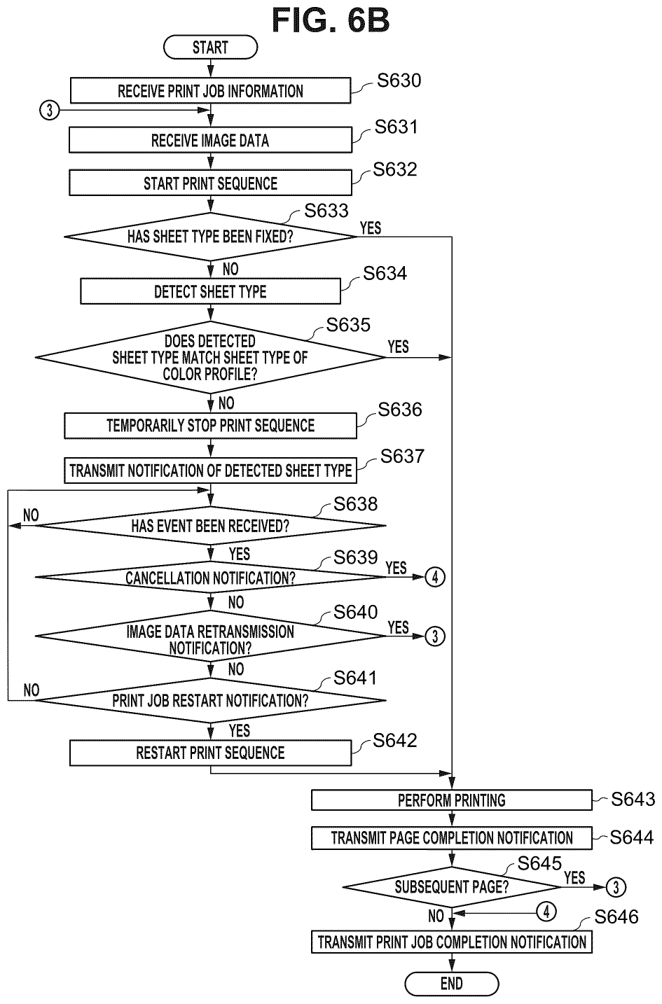

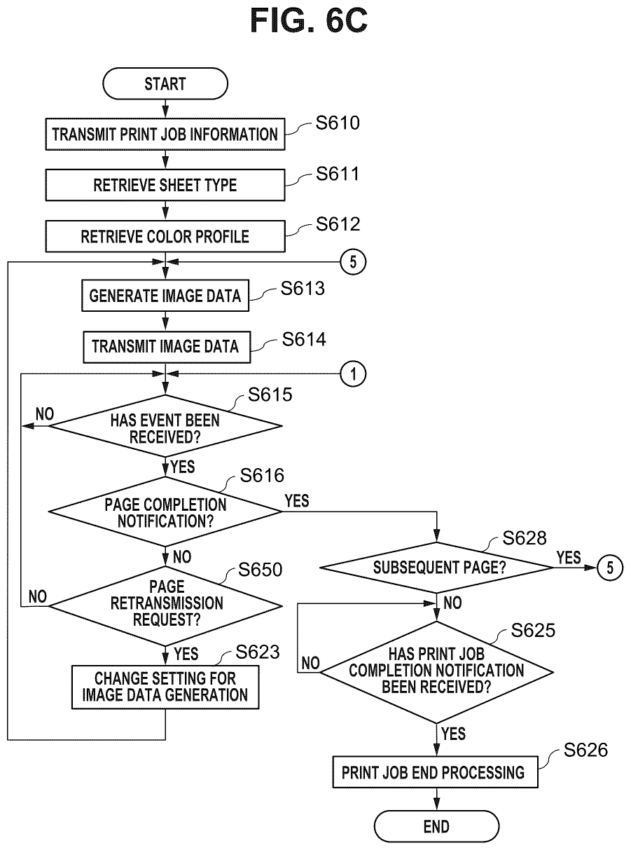

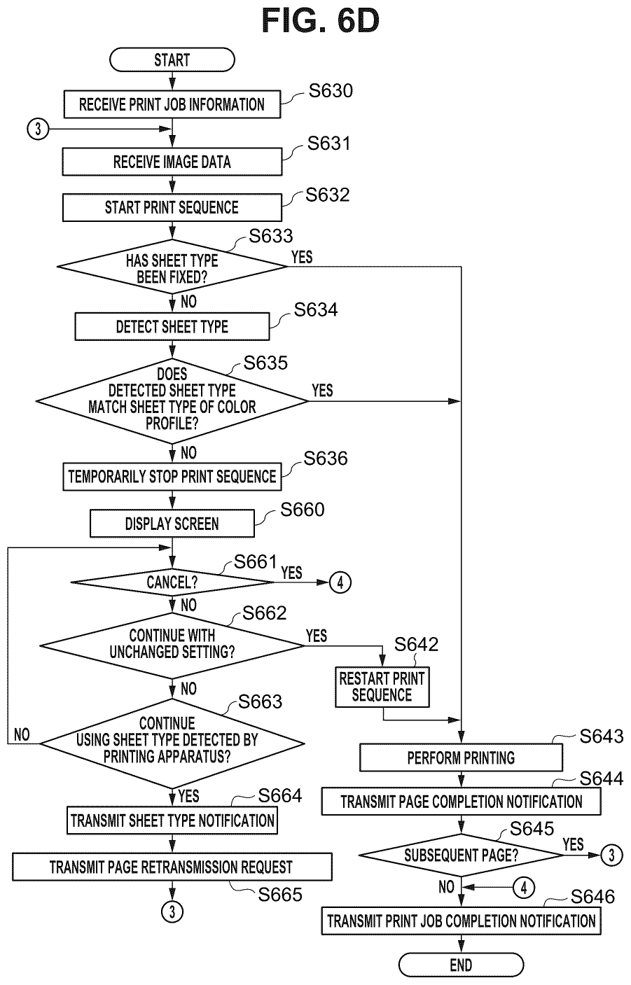

FIG. 5 is a diagram illustrating an example of a sheet type check screen 501. The sheet type check screen 501 is an example of a screen that is displayed in a case where the sheet type detected by the printing apparatus 101 does not match the sheet type of the color profile set by the information processing apparatus 109. The sheet type check screen 501 may be displayed on the UI panel 203 and/or the display unit 252. Examples of flowcharts in a case where the sheet type check screen 501 is displayed on the UI panel 203 and/or the display unit 252 will be described below (see FIGS. 6A, 6B, 6C, and 6D).

The sheet type check screen 501 includes a sheet type display field 502 and option buttons 503 to 505. A sheet type display field 502 is a field where the sheet type of the color profile and the sheet type detected using the media sensor 214 are displayed. The option button 503 is selected by the user when the user issues an instruction to continue the print job using the color profile set by the information processing apparatus 109. The option button 504 is selected by the user when the user issues an instruction to continue the print job using the color profile associated with the sheet type detected by the printing apparatus 101. The option button 505 is selected by the user when the user issues a cancellation of the print job.

FIG. 6A is a flowchart illustrating a first embodiment of processing that is performed by the information processing apparatus 109 according to a first embodiment. FIG. 6B is a flowchart illustrating the first embodiment of processing that is performed by the printing apparatus 101. FIGS. 6A and 6B are examples of flowcharts in a case where the sheet type check screen 501 is displayed on the display unit 252.

The processing of the flowchart in FIG. 6A will be described. The processing of the flowchart in FIG. 6A is implemented by, for example, the CPU 234 executing a program stored in the storage unit 236.

In step S610, the CPU 234 transmits print job information to the printing apparatus 101 via the NW I/F 238.

In step S611 and step S612, the CPU 234 retrieves the sheet type and the color profile set on the print job setting screen 401, respectively. In step S613, the CPU 234 generates image data based on the information retrieved in step S611 and step S612. In an embodiment, the image data is Cyan, Magenta, Yellow, and Black (CMYK) bitmap data. Further, the color profile is a lookup table for CMYK input and CMYK output that is used in adjustment of signal values of the respective CMYK colors to obtain a suitable printing result with respect to each sheet type. The CPU 234 refers to the lookup table to obtain an adjusted signal value (output) corresponding to a signal value (input) before the adjustment.

In step S614, the CPU 234 transmits the image data generated in step S613 to the printing apparatus 101 via the video I/F 233.

In step S615, the CPU 234 waits until the CPU 234 receives an event from the printing apparatus 101. In a case where the CPU 234 has received an event from the printing apparatus 101 (YES in step S615), the process proceeds to step S616. In step S616, the CPU 234 determines whether the event received from the printing apparatus 101 is a page completion notification. In a case where the CPU 234 determines that the event received from the printing apparatus 101 is a page completion notification (YES in step S616), the process proceeds to step S628, and the processing to be described below is performed.

On the other hand, in a case where the CPU 234 determines that the event received from the printing apparatus 101 is not a page completion notification (NO in step S616), the process proceeds to step S617. In step S617, the CPU 234 determines whether the event received from the printing apparatus 101 is a sheet type notification. In a case where the CPU 234 determines that the event received from the printing apparatus 101 is a sheet type notification (YES in step S617), the process proceeds to step S618. In step S618, the CPU 234 displays the sheet type check screen 501 on the display unit 252 and waits for an operation performed on the sheet type check screen 501.

In step S619, the CPU 234 determines whether the operation performed on the sheet type check screen 501 is an operation on the option button 505, i.e., whether a cancellation of the print job has been issued. In a case where the CPU 234 determines that a cancellation of the print job has been issued (YES in step S619), the process proceeds to step S624, and the processing to be described below is performed.

On the other hand, in a case where the CPU 234 determines that a cancellation of the print job has not been issued (NO in step S619), the process proceeds to step S620. In step S620, the CPU 234 determines whether the operation performed on the sheet type check screen 501 is an operation on the option button 503, i.e., whether an instruction to continue the print job with the setting that is unchanged has been issued. Continuing the print job with the unchanged setting means that the print job is continued with the color profile set on the print job setting screen 401 as the color profile set by the information processing apparatus 109. In a case where the CPU 234 determines that an instruction to continue the print job with the unchanged setting has been issued (YES in step S620), the process proceeds to step S627. In step S627, the CPU 234 transmits a print job restart notification to the printing apparatus 101 via the NW I/F 238. Then, the above-described processing in step S615 is performed again.

In a case where the CPU 234 determines that an instruction to continue the print job with the unchanged setting has not been issued (NO in step S620), the process proceeds to step S621. In step S621, the CPU 234 determines whether the operation performed on the sheet type check screen 501 is an operation on the option button 504, i.e., whether an instruction to continue the print job using the sheet type detected by the printing apparatus 101 has been issued. Continuing the print job using the sheet type detected by the printing apparatus 101 means continuing the print job using the color profile associated with the sheet type detected by the printing apparatus 101. In a case where the CPU 234 determines that an instruction to continue the print job using the sheet type detected by the printing apparatus 101 has not been issued (NO in step S621), the process returns to step S619, and the above-described processing in step S619 is performed again.

On the other hand, in a case where the CPU 234 determines that an instruction to continue the print job using the sheet type detected by the printing apparatus 101 has been issued (YES in step S621), the process proceeds to step S622. In step S622, the CPU 234 transmits an image data retransmission notification to the printing apparatus 101 via the NW I/F 238.

In step S623, the CPU 234 changes the setting for image data generation. In this processing, for example, the CPU 234 performs a setting to use the color profile associated with the sheet type determined as the one notified in step S617 instead of the color profile retrieved in step S612. Then, the above-described processing in step S613 is performed again.

In a case where the CPU 234 determines that a cancellation of the print job has been issued (YES in step S619), the process proceeds to step S624. In step S624, the CPU 234 transmits a cancellation notification to the printing apparatus 101 via the NW I/F 238.

In step S625, the CPU 234 waits until the CPU 234 receives a print job completion notification from the printing apparatus 101 via the NW I/F 238. In a case where the CPU 234 determines that the CPU 234 has received a print job completion notification from the printing apparatus 101 (YES in step S625), the process proceeds to step S626. In step S626, the CPU 234 performs print job end processing and ends the processing of the flowchart in FIG. 6A.

In a case where the CPU 234 determines that the event received from the printing apparatus 101 is a page completion notification (YES in step S616), the process proceeds to step S628. In step S628, the CPU 234 determines whether a subsequent page remains. In a case where the CPU 234 determines that a subsequent page remains (YES in step S628), the process returns to step S613, and the above-described processing in step S613 is performed again. On the other hand, in a case where the CPU 234 determines that no subsequent page remains (NO in step S628), the process proceeds to step S625, and the above-described processing in step S625 is performed again.

The processing of the flowchart in FIG. 6B will be described. The flowchart in FIG. 6B is implemented by, for example, the CPU 201 executing a program stored in the storage unit 205.

In step S630, the CPU 201 receives print job information via the NW I/F 207. The print job information received by the CPU 201 in step S630 is information transmitted from the information processing apparatus 109 and is the information transmitted in step S610.

In step S631, the CPU 201 receives image data via the video I/F 206 and stores the image data in the storage unit 205. In this processing, the CPU 201 may compress the image data and store the compressed image data in the storage unit 205. The image data received by the CPU 201 in step S631 is data transmitted from the information processing apparatus 109 and is the image data transmitted in step S614.

In step S632, the CPU 201 starts a print sequence.

In step S633, the CPU 201 determines whether the sheet type has been fixed. This determination is performed based on, for example, the sheet type designated by the print job. For example, in a case where automatic detection has been designated as the sheet type on the print job setting screen 401 illustrated in FIG. 4, the CPU 201 determines in step S633 that the sheet type has not been fixed.

In a case where the CPU 201 determines that the sheet type has been fixed (YES in step S633), the process proceeds to step S643, and the processing to be described below is performed. On the other hand, in a case where the CPU 201 determines that the sheet type has not been fixed (NO in step S633), the process proceeds to step S634. In step S634, the CPU 201 detects the sheet type based on a feature amount of the sheet measured by the media sensor 214.

In step S635, the CPU 201 determines whether the sheet type detected in step S634 and the sheet type of the color profile designated by the print job match each other. In a case where the CPU 201 determines that the sheet types match each other (YES in step S635), the process proceeds to step S643, and the processing to be described below is performed. On the other hand, in a case where the CPU 201 determines that the sheet types do not match each other (NO in step S635), the process proceeds to step S636. In step S636, the CPU 201 temporarily stops the print sequence.

In step S637, the CPU 201 notifies the information processing apparatus 109 of the sheet type detected in step S634 via the NW I/F 207. Based on this notification, a determination result in step S617 in FIG. 6A is YES.

In step S638, the CPU 201 waits until the CPU 201 receives an event from the information processing apparatus 109. In a case where the CPU 201 has received an event from the information processing apparatus 109 (YES in step S638), the process proceeds to step S639. In step S639, the CPU 201 determines whether the event is a cancellation notification. In a case where the CPU 201 determines that the event received from the information processing apparatus 109 is a cancellation notification (YES in step S639), the process proceeds to step S646, and the processing to be described below is performed.

On the other hand, in a case where the CPU 201 determines that the event received from the information processing apparatus 109 is not a cancellation notification (NO in step S639), the process proceeds to step S640. In step S640, the CPU 201 determines whether the event received from the information processing apparatus 109 is an image data retransmission notification. In a case where the CPU 201 determines that the event received from the information processing apparatus 109 is an image data retransmission notification (YES in step S640), the process returns to step S631, and the above-described processing in step S631 is performed again.

On the other hand, in a case where the CPU 201 determines that the event received from the information processing apparatus 109 is not an image data retransmission notification (NO in step S640), the process proceeds to step S641. In step S641, the CPU 201 determines whether the event received from the information processing apparatus 109 is a restart notification. In a case where the CPU 201 determines that the event received from the information processing apparatus 109 is not a restart notification (NO in step S641), the process returns to step S638, and the above-described processing in step S638 is performed again.

On the other hand, in a case where the CPU 201 determines that the event received from the information processing apparatus 109 is a restart notification (YES in step S641), the process proceeds to step S642. In step S642, the CPU 201 restarts the suspended print sequence and, in step S643, performs printing.

In step S643, for example, the following processing is performed. The CPU 201 retrieves and develops the image data stored in the storage unit 205 in step S631, and perform image processing including tone processing, such as color space conversion and gamma correction. The image processing includes image processing corresponding to the sheet type. In a case where the sheet type is detected using the media sensor 214, the CPU 201 performs image processing according to the detected sheet type. For example, in gamma correction that is performed as the gradation processing, the CPU 201 uses a lookup table in which gamma values for different sheet types are stored, to perform gamma correction using a gamma value appropriate to the sheet type. Then, the printer engine 210 prints an image obtained by the image processing on a sheet and outputs (discharges) the sheet.

After the completion of printing of one page in step S643, the CPU 201 issues a page completion notification in step S644. The page completion notification is transmitted to the information processing apparatus 109 via the NW I/F 207. Based on the processing in step S643, a determination result in step S616 in FIG. 6A is YES.

In step S645, the CPU 201 determines whether a subsequent page remains. In a case where the CPU 201 determines that a subsequent page remains (YES in step S645), the process returns to step S631, and the above-described processing in step S631 is performed again. On the other hand, in a case where the CPU 201 determines that no subsequent page remains (NO in step S645), the process proceeds to step S646. In step S646, the CPU 201 issues a print job completion notification and ends the processing in the flowchart in FIG. 6B. The print job completion notification is transmitted to the information processing apparatus 109 via the NW I/F 207. Based on the processing in step S646, a determination result in step S625 in FIG. 6A is YES. As described above, in a case where the CPU 201 determines that the event received from the information processing apparatus 109 is a cancellation notification (YES in step S639), the process proceeds to step S646, and the above-described processing in step S646 is performed.

FIG. 6C is a flowchart illustrating a second embodiment of processing that is performed by the information processing apparatus 109 according to a second exemplary embodiment. FIG. 6D is a flowchart illustrating the second embodiment of processing that is performed by the printing apparatus 101. FIGS. 6C and 6D are examples of flowcharts in a case where the sheet type check screen 501 is displayed on the UI panel 203.

The flowchart in FIG. 6C is implemented by, for example, the CPU 234 executing a program stored in the storage unit 236. The parts different from the flowchart in FIG. 6A will be described, and the redundant description will be omitted. The flowchart in FIG. 6C differs from the flowchart in FIG. 6A in the processing that is performed in a case where the CPU 234 determines in step S616 that the event received from the printing apparatus 101 is not a page completion notification.

In a case where the CPU 234 determines that the event received from the printing apparatus 101 is not a page completion notification (NO in step S616), the process proceeds to step S650. In step S650, the CPU 234 determines whether the event received from the printing apparatus 101 is a page retransmission request (image data retransmission request). In a case where the CPU 234 determines that the event received from the printing apparatus 101 is a page retransmission request (YES in step S650), the process proceeds to step S623, and the above-described processing in step S623 is performed. In the present exemplary embodiment, as in steps S664 and S665 in FIG. 6D to be described below, in receiving of a page retransmission request by the information processing apparatus 109, the information processing apparatus 109 also receives a sheet type detected by the printing apparatus 101. In this case, in step S623, the CPU 234 changes the setting for image data generation, based on the sheet type detected by the printing apparatus 101. On the other hand, in a case where the CPU 234 determines that the event received from the printing apparatus 101 is not a page retransmission request (NO in step S650), the process returns to step S615, and the above-described processing in step S615 is performed again.

The processing in the flowchart in FIG. 6C other than the processing described above is similar to the processing in the flowchart in FIG. 6A, and the redundant description will be omitted.

The flowchart in FIG. 6D is implemented by, for example, the CPU 201 executing a program stored in the storage unit 205. The parts different from the flowchart in FIG. 6B will be described, and the redundant description will be omitted. The flowchart in FIG. 6D differs from the flowchart in FIG. 6B for the processing that is performed after the print sequence is temporarily stopped by the CPU 201 in step S636. In response to the print sequence being temporarily stopped in step S636, processing of step S660 is performed.

In step S660, the CPU 201 displays the sheet type check screen 501 on the UI panel 203 and waits for an operation performed on the sheet type check screen 501. In step S661, the CPU 201 determines whether the operation performed on the sheet type check screen 501 is an operation on the option button 505, i.e., whether a cancellation of the print job has been issued. In step S661, in a case where the CPU 201 determines that a cancellation of the print job has been issued (YES in step S661), the process proceeds to step S646, and the above-described processing in step S646 is performed.

In a case where the CPU 201 determines that a cancellation of the print job has not been issued (NO in step S661), the process proceeds to step S662. In step S662, the CPU 201 determines whether the operation performed on the sheet type check screen 501 is an operation on the option button 503, i.e., whether an instruction to continue the print job with the unchanged setting has been issued. In step S662, in a case where the CPU 201 determines that an instruction to continue the print job with the unchanged setting has been issued (YES in step S662), the process proceeds to step S642, and the above-described processing in step S642 is performed.

In a case where the CPU 201 determines that an instruction to continue the print job with the unchanged setting has not been issued (NO in step S662), the process proceeds to step S663. In step S663, the CPU 201 determines whether the operation performed on the sheet type check screen 501 is an operation on the option button 504, i.e., whether an instruction to continue the print job using the sheet type detected by the printing apparatus 101 has been issued. In a case where the CPU 201 determines that an instruction to continue the print job using the sheet type detected by the printing apparatus 101 has not been issued (NO in step S663), the process returns to step S661, and the above-described processing in step S661 is performed again.

In a case where the CPU 201 determines that an instruction to continue the print job using the sheet type detected by the printing apparatus 101 has been issued (YES in step S663), the process proceeds to step S664. In step S664, the CPU 201 notifies the information processing apparatus 109 of the sheet type detected in step S634 to the information processing apparatus 109 via the NW I/F 207. In step S665, the CPU 201 transmits a page retransmission request (image data retransmission request) to the printing apparatus 101 via the NW I/F 238.

Then, the process returns to step S631, and the processing in step S631 is performed again.

As described above, in a case where the CPU 234 determines in step S650 in FIG. 6C that the event received from the printing apparatus 101 is a page retransmission request (image data retransmission request), the information processing apparatus 109 has also received the sheet type from the printing apparatus 101. Thus, in step S623 in FIG. 6C, in changing of the setting for image data generation, the CPU 234 is able to set and use the color profile associated with the received sheet type instead of the color profile retrieved in step S612.

The processing in the flowchart in FIG. 6D other than the above-described processing is similar to the processing in the flowchart in FIG. 6B, and the redundant description will be omitted.

As described above, in a case where the sheet type of the color profile designated in the print job does not match the sheet type detected by the printing apparatus 101, the printing apparatus 101 requests the information processing apparatus 109 to generate image data (bitmap data). Therefore, the information processing apparatus 109 generates image data appropriate to the sheet type detected by the printing apparatus 101 and transmits the image data to the printing apparatus 101. This configuration leads to the achievement of suppressing a decrease in the quality of a printed product that is obtained by the printing apparatus 101 processing image data processed in the information processing apparatus 109.

A second exemplary embodiment will be described. In the first exemplary embodiment, the sheet type check screen 501 is displayed in a case where the sheet type of the color profile designated by the print job does not match the sheet type detected by the printing apparatus 101. In contrast, a description will be given of a case where another sheet type check screen is displayed in a case where the sheet type is detected by the printing apparatus 101. As described above, the present exemplary embodiment and the first exemplary embodiment are different from each other mainly in the configuration and processing related to displaying of the sheet type check screen. In the description of the present exemplary embodiment, the similar parts to those of the first exemplary embodiment are denoted by the same symbols as those given to FIG. 1 to FIG. 6D, and the detailed description is incorporated by reference, without repetition, for conciseness.

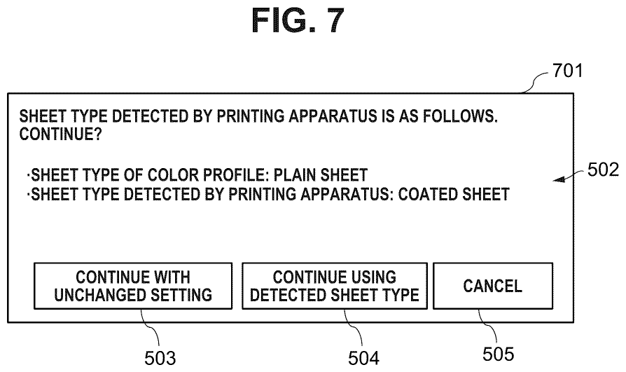

FIG. 7 is a diagram illustrating an example of a sheet type check screen 701 according to an embodiment. The sheet type check screen 701 is a screen that is displayed in response to detection of the sheet type in the printing apparatus 101, regardless of whether the sheet type matches the sheet type of the color profile designated by the print job. Thus, unlike the sheet type check screen 501 illustrated in FIG. 5, the sheet type check screen 701 illustrated in FIG. 7 does not display a message notifying that the sheet types do not match each other.

The sheet type check screen 701 illustrated in FIG. 7 is displayed even in a case where the sheet type of the color profile designated by the print job and the sheet type detected by the printing apparatus 101 match each other. In FIG. 7, the buttons displayed on the sheet type check screen 701 are the same between a case where the sheet type of the color profile designated by the print job matches the sheet type detected by the printing apparatus 101 and a case where the sheet type of the color profile designated by the print job does not match the sheet type detected by the printing apparatus 101. However, buttons displayed on the sheet type check screen 701 may be different between those cases based on whether the sheet type of the color profile designated by the print job matches the sheet type detected by the printing apparatus 101. For example, in a case where the sheet type of the color profile designated by the print job and the sheet type detected by the printing apparatus 101 match each other, one option button may be displayed on the sheet type check screen 701 instead of the option buttons 503 and 504. In a case where the one option button is operated, for example, the print job is continued as it is.

In a case where the one option button is displayed on the sheet type check screen 701, a configuration may be applied that the option button 505 that is operated by the user to issue a cancellation of the print job is not displayed on the sheet type check screen 701.

An example of the processing of the printing apparatus 101 and the information processing apparatus 109 according to the present exemplary embodiment is as follows.

A determination result in step S617 in FIG. 6A is YES. Further, a determination result in step S635 in FIG. 6B is NO. In step S618 in FIG. 6A, the sheet type check screen 701 illustrated in FIG. 7 is displayed on the display unit 252.

Further, a determination result in step S635 in FIG. 6D is NO. In step S660 in FIG. 6D, the sheet type check screen 701 illustrated in FIG. 7 is displayed on the UI panel 203.

According to the present exemplary embodiment, the user can determine a form of the print job to be continued after checking the setting each time regardless of whether the sheet type set in the print job setting screen 401 and the sheet type detected by the printing apparatus 101 match or mismatch each other.

A third exemplary embodiment will be described. In the first and second exemplary embodiments, the sheet type check screens 501 and 701, respectively, are displayed. In contrast, in the present exemplary embodiment, a description will be given of a case where the setting is automatically changed to a setting corresponding to the sheet type detected by the printing apparatus 101 and printing is performed, without displaying the sheet type check screens 501 and 701. As described above, the present exemplary embodiment is different from the first and second exemplary embodiments mainly in the configuration and processing related to not displaying the sheet type check screen. In the description of the present exemplary embodiment, the similar parts to those of the first and second exemplary embodiments are denoted by the same reference numerals as those in FIGS. 1 to 7, and the detailed redundant description will be omitted.

An example of the processing of the printing apparatus 101 and the information processing apparatus 109 according to the present exemplary embodiment is as follows.

The processing in step S618 in FIG. 6A is skipped. Determination results in step S619 and step S620 in FIG. 6A are NO. Thus, the processing in steps S624 and S627 in FIG. 6A is not performed. Further, a determination result in step S621 in FIG. 6A is YES.

The processing in step S660 in FIG. 6D is also skipped. Further, determination results in steps S661 and S662 in FIG. 6D are NO. Thus, the processing in step S642 in FIG. 6D is not performed. Further, a determination result in step S663 in FIG. 6D is YES.

In the present exemplary embodiment, the information processing apparatus 109 automatically generates image data (bitmap) appropriate to the sheet type detected by the printing apparatus 101 without causing the user to perform setting. Thus, this configuration leads to the achievement of reducing the burden on the user in suppressing a decrease in the quality of a printed product that is obtained by the printing apparatus 101 processing the image data processed by the information processing apparatus 109.

A fourth exemplary embodiment will be described. In the first to third exemplary embodiments, the print sequence is temporarily stopped in a case where the sheet type detected by the printing apparatus 101 does not match the sheet type of the color profile set by the information processing apparatus 109 (see steps S635 and S636 in FIGS. 6B and 6D). In other words, in the first to third exemplary embodiments, the print sequence is not stopped in a case where the sheet type detected by the printing apparatus 101 and the sheet type of the color profile set by the information processing apparatus 109 match each other. In contrast, in the present exemplary embodiment, a description will be given of a case where the print sequence is stopped in a case where printing is performed on a sheet of which the sheet type has not been fixed. As described above, the present exemplary embodiment is different from the first to third exemplary embodiments mainly in the configuration and processing related to stopping of the print sequence. Thus, in the description of the present exemplary embodiment, the similar parts to those of the first to third exemplary embodiments are denoted by the same reference numerals as those in FIGS. 1 to 7, and the detailed redundant description will be omitted.

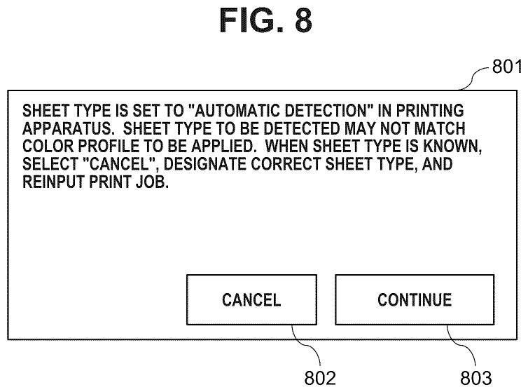

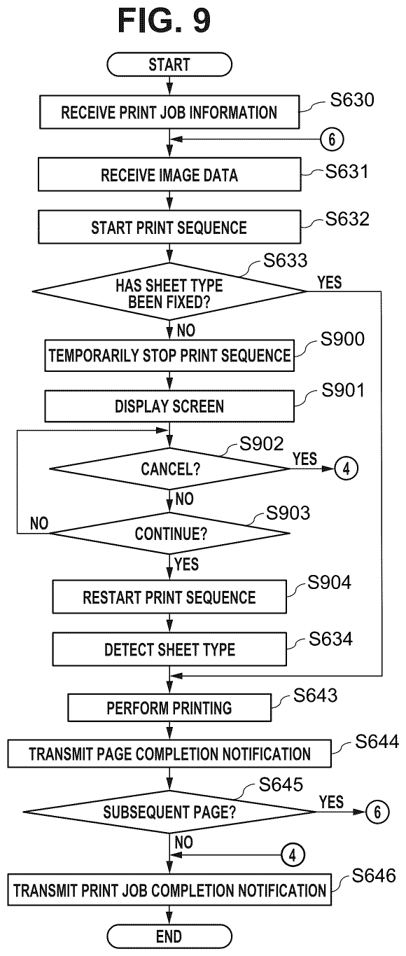

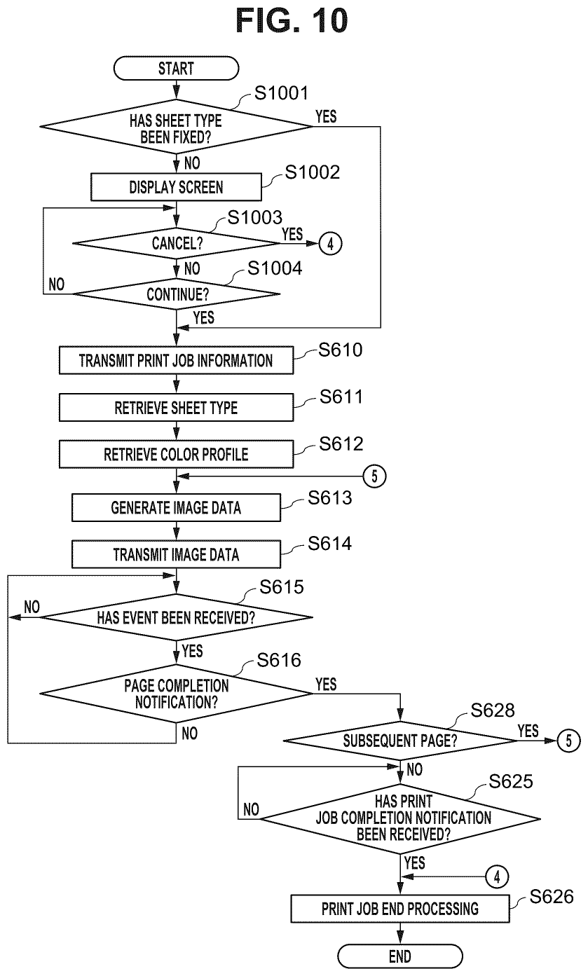

FIG. 8 is a diagram illustrating an example of a setting check screen 801. The setting check screen 801 is an example of a screen displayed in response to the start of a print job executed after designation of a sheet of which the sheet type has not been fixed. The setting check screen 801 may be displayed on the UI panel 203 and/or the display unit 252. Examples of flowcharts in a case where the setting check screen 801 is displayed on the UI panel 203 and/or the display unit 252 will be described below (see FIGS. 9 and 10).

Option buttons 802 and 803 are displayed on the setting check screen 801. The option button 802 is a button that is selected by the user when a cancellation of the print job is issued. The option button 803 is a button that is selected by the user when an instruction to continue the print job with the setting of the print job is issued.

FIG. 9 is a flowchart illustrating an example of processing that is performed by the printing apparatus 101 according to the present exemplary embodiment. FIG. 9 is an example of a flowchart for displaying of the setting check screen 801 on the UI panel 203. The parts different from the flowchart in FIG. 6D will be described, and the redundant description will be omitted. The flowchart in FIG. 9 is different from the flowchart in FIG. 6D for the processing that is performed in a case where the CPU 201 determines in step S633 that the sheet type has not been fixed.

In a case where the CPU 201 determines that the sheet type has not been fixed (NO in step S633), the process proceeds to step S900. In step S900, the CPU 201 temporarily stops the print sequence.

In step S901, the CPU 201 displays the setting check screen 801 on the UI panel 203 and waits for an operation performed on the setting check screen 801. In step S902, the CPU 201 determines whether the operation performed on the setting check screen 801 is an operation on the option button 802, i.e., whether a cancellation of the print job has been issued. In a case where the CPU 201 determines that a cancellation of the print job has been issued (YES in step S902), the process proceeds to step S646, and the above-described processing in step S646 is performed.

On the other hand, in a case where CPU 201 determines that a cancellation of the print job has not been issued (NO in step S902), the process proceeds to step S903. In step S903, the CPU 201 determines whether the operation performed on the setting check screen 801 is an operation on the option button 803, i.e., whether an instruction to continue the print job has been issued. In a case where the CPU 201 determines that an instruction to continue the print job has not been issued (NO in step S903), the process returns to step S902, and the above-described processing in step S902 is performed again.

On the other hand, in a case where the CPU 201 determines that an instruction to continue the print job has been issued (YES in step S903), the process proceeds to step S904. In step S904, the CPU 201 restarts the print sequence. After the completion of the processing in step S904, the above-described processing in step S634 is performed, and the sheet type is detected.

The processing in the flowchart in FIG. 9 other than the above-described processing is similar to the processing in the flowchart in FIG. 6D, and the redundant description will be omitted.

The flowchart that is executed by the CPU 234 is, for example, a flowchart modified as follows from the flowchart in FIG. 6C. The processing in steps S650 and S623 in FIG. 6C is not performed. In a case where a determination result in step S616 in FIG. 6C is NO, the processing in step S615 in FIG. 6C is performed again. The processing other than the above-described processing is similar to the processing in the flowchart in FIG. 6C, and the redundant description will be omitted.

FIG. 10 is a flowchart illustrating an example of processing that is performed by the information processing apparatus 109 according to the present exemplary embodiment. FIG. 10 is an example of a flowchart for processing in which the setting check screen 801 is displayed on the display unit 252. The parts different from the flowchart in FIG. 6C will be described, and the redundant description will be omitted. The flowchart in FIG. 10 differs from the flowchart in FIG. 6C in that processing in steps S1001 to S1004 is added at the beginning of the flowchart, and the processing in steps S650 and S623 in FIG. 6C is not performed.

In step S1001, the CPU 234 determines whether the sheet type has been fixed. For example, in a case where automatic detection has been designated as the sheet type in the print job setting screen 401, the CPU 234 determines that the sheet type has not been fixed. On the other hand, in a case where any sheet type other than automatic detection has been designated in the print job setting screen 401, the CPU 234 determines that the sheet type has been fixed.

In a case where the CPU 234 determines that the sheet type has been fixed (YES in step S1001), the process proceeds to step S610, and the above-described processing in step S610 is performed. On the other hand, in a case where the CPU 234 determines that the sheet type has not been fixed (NO in step S1001), the process proceeds to step S1002. In step S1002, the CPU 234 displays the setting check screen 801 on the display unit 252 and waits for an operation performed on the setting check screen 801. In step S1003, the CPU 234 determines whether the operation performed on the setting check screen 801 is an operation on the option button 802, i.e., whether a cancellation of the print job has been issued. In a case where the CPU 234 determines that a cancellation of the print job has been issued (YES in step S1003), the process proceeds to step S626, and the above-described processing in step S626 is performed.

On the other hand, in a case where the CPU 234 determines that a cancellation of the print job has not been issued (NO in step S1003), the process proceeds to step S1004. In step S1004, the CPU 234 determines whether the operation performed on the setting check screen 801 is an operation on the option button 803, i.e., whether an instruction to continue the print job has been issued. In a case where the CPU 234 determines that an instruction to continue the print job has not been issued (NO in step S1004), the process returns to step S1003, and the above-described processing in step S1003 is performed again.

On the other hand, in a case where the CPU 234 determines that an instruction to continue the print job has been issued (YES in step S1004), the process proceeds to step S610, and the above-described processing in step S610 is performed.

As described with reference to FIG. 6C, in a case where a determination result in step S616 is that the event received from the printing apparatus 101 is a page completion notification (YES in step S616), the process proceeds to step S628, and the processing in step S628 is performed. This is similar to the flowchart in FIG. 10. On the other hand, in a case where a determination result in step S616 is that the event received from the printing apparatus 101 is not a page completion notification (NO in step S616), the process proceeds to steps S650 and S623 in FIG. 6C, and the processing in steps S650 and S623 is performed. In contrast, in the flowchart in FIG. 10, in a case where a determination result in step S616 is that the event received from the printing apparatus 101 is not a page completion notification (NO in step S616), the process proceeds to step S615 without the processing in steps S650 and S623, and the above-described processing in step S615 is performed again.

The processing in the flowchart in FIG. 10 other than the above-described processing is similar to the processing in the flowchart in FIG. 6C, and the redundant description will be omitted.

An example of a flowchart that is executed by the CPU 201 in this case is a flowchart modified from FIG. 10 by omitting steps S1001 to S1004, and thus the detailed description will be omitted.

According to the present exemplary embodiment, the user can find out in advance (before the print job is input) that printing may be performed with a sheet type setting that is different from the sheet type that is set in the print job setting screen 401. Such configuration prevents output of a printed product based on an undesired setting.

A fifth exemplary embodiment will be described. In the present exemplary embodiment, before the start of the print job, the user is caused to perform a selection on the screens (the sheet type check screens 501 and 701 and the setting check screen 801) which is performed, in the first, second, and fourth exemplary embodiments, after the issuance of an instruction to start the print job. As described above, the present exemplary embodiment is different from the first, second, and fourth exemplary embodiments mainly in the selection timing of how the print job is to be handled, in a case where the sheet type of the color profile designated by the print job does not match the sheet type detected by the printing apparatus 101. Thus, in the description of the present exemplary embodiment, the similar parts to those of the first, second, and fourth exemplary embodiments are denoted by the same reference numerals as those in FIGS. 1 to 10, and the detailed redundant description will be omitted.

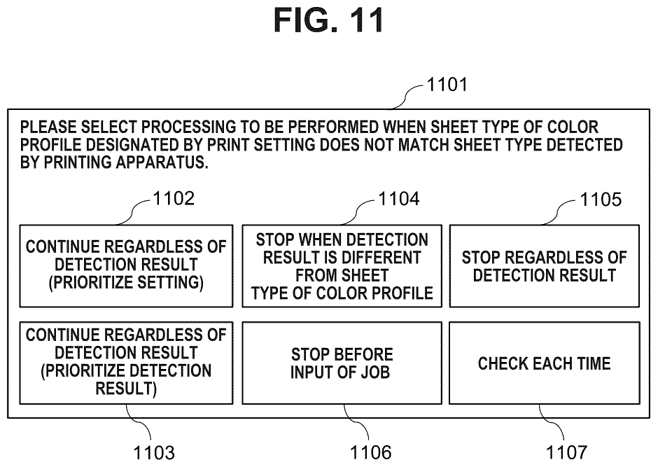

FIG. 11 is a diagram illustrating an example of a check enable/disable setting screen 1101.

The check enable/disable setting screen 1101 is displayed on the display unit 252, for example, in response to when the OK button 402 is pressed with automatic detection designated as the sheet type in the print job setting screen 401. The configuration according to the present exemplary embodiment is not limited to this. For example, the check enable/disable setting screen 1101 may be displayed in a pop-up manner in response to when automatic detection is designated as the sheet type in the print job setting screen 401. The check enable/disable setting screen 1101 may be displayed on the display unit 252 without being linked with the print job setting screen 401. In this case, a selection on the check enable/disable setting screen 1101 may be a selection common to a plurality of print jobs. The check enable/disable setting screen 1101 may be displayed on the UI panel 203.

In FIG. 11, option buttons 1102 to 1107 are displayed on the check enable/disable setting screen 1101. In a case where any one of the option buttons 1102 to 1106 is selected, the sheet type check screens 501 and 701 and the setting check screen 801 described in the first, second, and fourth exemplary embodiments are not displayed. On the other hand, in a case where the option button 1107 is selected, the sheet type check screens 501 and 701 and the setting check screen 801 are displayed as described in the first, second, and fourth exemplary embodiments.

The option button 1102 is a button that is selected by the user in issuance of an instruction to continue the print job using the color profile set by the information processing apparatus 109. The selection of the option button 1102 corresponds to a selection of the option button 503 in FIG. 5.

The option button 1103 is a button that is selected by the user in issuance of an instruction to continue the print job using a color profile associated with the sheet type detected by the printing apparatus 101. The selection of the option button 1103 corresponds to a selection of the option button 504 in FIG. 5.

The option button 1104 is a button that is selected by the user in issuance of a cancellation of the print job in a case where the sheet type of the color profile designated by the print job does not match the sheet type detected by the printing apparatus 101. The selection of the option button 1104 corresponds to a selection of the option button 505 in FIG. 5.

The option button 1105 is a button that is selected by the user in issuance of a cancellation of the print job regardless of the sheet type detected by the printing apparatus 101. The selection of the option button 1105 corresponds to a selection of the option button 505 in FIG. 7.

The option button 1106 is a button that is selected by the user in issuance of a cancellation of the print job before transmission of the print job to the printing apparatus 101. The selection of the option button 1106 corresponds to a selection of the option button 802 in FIG. 8.

The option button 1107 is a button that is selected by the user in issuance of an instruction to display the sheet type check screens 501 and 701 and the setting check screen 801.

Not all the option buttons 1102 to 1107 may be displayed on the check enable/disable setting screen 1101. For example, a configuration may be applied that the option button 1107 is not displayed. In addition to the option buttons 1102 to 1106, an option button by which an instruction for whether to continue the print job is issued may be displayed on the check enable/disable setting screen 1101.

An example of processing of the printing apparatus 101 and the information processing apparatus 109 according to the present exemplary embodiment is as follows.

In a case where any one of the option buttons 1102 to 1104 is selected, the processing according to the first exemplary embodiment is performed. In this case, the processing in step S618 in FIG. 6A is not performed. The determinations in steps S619 to S621 are performed based on a result of the selection from among the option buttons 1102 to 1104. The processing in step S660 in FIG. 6D is not performed. The determinations in steps S661 to S663 are performed based on a result of the selection from among the option buttons 1102 to 1104.

In a case where the option button 1105 is selected, the processing according to the second exemplary embodiment is performed. In this case, the processing in step S618 in FIG. 6A is not performed. A determination result in step S619 is YES. The processing in steps S620 to S623 and step S627 is also not performed. The processing in step S660 in FIG. 6D is also not performed. Further, a determination result in step S661 is YES. The processing in steps S662 to S665 and step S642 is also not performed.

In a case where the option button 1106 is selected, the processing according to the fourth exemplary embodiment is performed. In this case, the processing in step S901 in FIG. 9 is not performed. A determination result in step S902 is YES. The processing in steps S903, S904, and S634 is also not performed. The processing in step S1002 in FIG. 10 is also not performed. Further, a determination result in step S1003 is YES. The processing in step S1004 in FIG. 10 is also not performed.

With the configuration according to the present exemplary embodiment, displaying that is performed in response to detection of the sheet type in the printing apparatus 101 and prompts the user to check the sheet type is prevented from being performed after the start of the print job. This leads to, for example, suppression of a decrease in the production efficiency of printed products. For example, in a case where the user leaves the printing apparatus 101 or the information processing apparatus 109 after the print setting, the printing is prevented from being left in a stopped state.

The disclosure of the present exemplary embodiment includes, for example, configurations, methods, and programs that include the following configurations.

### (Configuration 1)

A printing system comprising:

a printing control apparatus; and

a printing apparatus,

wherein the printing control apparatus includes:
a first receiving unit configured to receive a sheet type setting,
a designation unit configured to designate a profile based on the sheet type setting,
a generation unit configured to generate bitmap data based on the designated profile, and
a first transmission unit configured to transmit, to the printing apparatus, the generated bitmap data and information on the profile including the sheet type setting,

wherein the printing apparatus includes
a second receiving unit configured to receive the bitmap data and the information on the profile,
a detection unit configured to detect a type of sheet being conveyed along a conveyance path, and
a second transmission unit configured to transmit, to the printing control apparatus, in a case where the type of sheet detected by the detection unit does not match a sheet type corresponding to the information on the profile, a request for generation of bitmap data based on the type of sheet detected by the detection unit,

wherein the first transmission unit transmits, to the printing apparatus, the bitmap data that has been generated based on the request, and

wherein the printing apparatus is configured to print an image on a sheet, based on the bitmap data that has been received by the second receiving unit.

### (Configuration 2)

The printing system according to configuration 1, wherein the second transmission unit transmits the request to the printing control apparatus regardless of whether the type of sheet detected by the detection unit matches the sheet type corresponding to the information on the profile.

### (Configuration 3)

The printing system according to configuration 1 or 2, wherein the first transmission unit transmits, in a case where an instruction has been issued by a user, the bitmap data generated based on the request.

### (Configuration 4)

The printing system according to configuration 3, further comprising:

a display unit configured to display, on a display device, a screen on which the instruction is to be issued,

wherein the display unit is provided on at least one of the printing control apparatus and the printing apparatus.

### (Configuration 5)

The printing system according to any one of configurations 1 to 4,

wherein the second transmission unit transmits, in a case where the detected type of sheet does not match the sheet type corresponding to the information on the profile, information on the detected sheet type instead of or in addition to the request, and

wherein the first transmission unit transmits the bitmap data that has been generated based on the information on the sheet type setting, and

wherein the printing of the image on the sheet by the printing apparatus is based on the bitmap data that has been received by the second receiving unit and generated based on the information on the profile including the sheet type setting.

### (Method 1)

A method for controlling a printing system including a printing control apparatus and a printing apparatus, the control method comprising:

executing, by the printing control apparatus, a process including
receiving a sheet type setting,
designating a profile based on the sheet type setting,
generating bitmap data based on the designated profile, and
transmitting, as a first transmission, the generated bitmap data and information on the profile to the printing apparatus including the sheet type setting; and

executing, by the printing apparatus, a process including
receiving the bitmap data and the information on the profile,
detecting a type of sheet being conveyed along a conveyance path, and
transmitting, as a second transmission, in a case where the type of the detected sheet does not match a sheet type corresponding to the information on the profile, a request for generation of bitmap data based on the type of detected sheet to the printing control apparatus,

wherein the first transmission transmits the bitmap data that has been generated based on the request, and

printing an image on a sheet, based on the received bitmap data that has been generated based on the request.

According to the present disclosure, a decrease in the quality of a printed product is suppressed in printing of an image based on bitmap data transmitted from a printing control apparatus.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., an ASIC) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., CPU, micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a RAM, a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-155626, filed Sep. 21, 2023, which is hereby incorporated by reference herein in its entirety.

What is claimed is:

1. A printing system comprising:
a printing control apparatus; and
a printing apparatus,
wherein the printing control apparatus includes:
a first receiving unit configured to receive a sheet type setting,
a designation unit configured to designate a profile based on the sheet type setting,
a generation unit configured to generate bitmap data based on the designated profile, and
a first transmission unit configured to transmit, to the printing apparatus, the generated bitmap data and information on the profile including the sheet type setting,
wherein the printing apparatus includes:
a second receiving unit configured to receive the bitmap data and the information on the profile,
a detection unit configured to detect a type of sheet being conveyed along a conveyance path, and
a second transmission unit configured to transmit to the printing control apparatus, in a case where the type of sheet detected by the detection unit does not match a sheet type corresponding to the information on the profile, a request for generation of bitmap data based on the type of sheet detected by the detection unit,
wherein the first transmission unit transmits, to the printing apparatus, the bitmap data that has been generated based on the request, and
wherein the printing apparatus is configured to print an image on a sheet, based on the bitmap data that has been received by the second receiving unit.

2. The printing system according to claim 1, wherein the second transmission unit transmits the request to the printing control apparatus regardless of whether the type of sheet detected by the detection unit matches the sheet type corresponding to the information on the profile.

3. The printing system according to claim 1, wherein the first transmission unit transmits, in a case where an instruction has been issued by a user, the bitmap data generated based on the request.

4. The printing system according to claim 3, further comprising:
a display unit configured to display, on a display device, a screen on which the instruction is to be issued,
wherein the display unit is provided on at least one of the printing control apparatus and the printing apparatus.

5. The printing system according to claim 1,
wherein the second transmission unit transmits, in a case where the detected type of sheet does not match the sheet type corresponding to the information on the profile, information on the detected sheet type instead of or in addition to the request,
wherein the first transmission unit transmits the bitmap data that has been generated based on the information on the sheet type setting, and
wherein the printing of the image on the sheet by the printing apparatus is based on the bitmap data that has been received by the second receiving unit and generated based on the information on the profile including the sheet type setting.

6. A method for controlling a printing system including a printing control apparatus and a printing apparatus, the control method comprising:
executing, by the printing control apparatus, a process including:
receiving a sheet type setting,
designating a profile based on the sheet type setting,
generating bitmap data based on the designated profile, and
transmitting, as a first transmission, the generated bitmap data and information on the profile to the printing apparatus including the sheet type setting;
executing, by the printing apparatus, a process including:
receiving the bitmap data and the information on the profile,
detecting a type of sheet being conveyed along a conveyance path, and
transmitting, as a second transmission, in a case where the type of the detected sheet does not match a sheet type corresponding to the information on the profile, a request for generation of bitmap data based on the type of detected sheet to the printing control apparatus, and
wherein the first transmission transmits the bitmap data that has been generated based on the request; and
printing an image on a sheet, based on the received bitmap data that has been generated based on the request.
